(19) United States
(12) Patent Application Publication
(10) Pub. No.: US 2012/0290320 A1
(43) Pub. Date: Nov. 15, 2012

(54) SYSTEM FOR LEVERAGING SOCIAL AND RESTRICTED AVAILABILITY CONTENT IN CLINICAL PROCESSES, AND A METHOD THEREOF

(76) Inventors: Michael J. Kurgan, Miami Beach, FL (US); Ranjeet Vijaykumar Deshmukh, Aurangabad Maharashtra (IN)

(21) Appl. No.: 13/306,709

(22) Filed: Nov. 29, 2011

Related U.S. Application Data
(63) Continuation-in-part of application No. 13/107,664, filed on May 13, 2011.

(51) Int. Cl. G06Q 50/24

(52) U.S. Cl. 705/3

(57) ABSTRACT

A system for data integration and collation of medical data is described. The system includes: a plurality of data stores comprising untraditional profile data; a gateway communicating with the data stores; a database comprising a patient medical record, a prescribed protocol, and a rule set describing the prescribed protocol; and a medical rule evaluator for accessing the rule set and applying the rule set to the untraditional profile data to generate key indicators. Also described is a data collection system including a plurality of data sources and a plurality of connectors, wherein the data sources include data from a untraditional profile data source and a clinical data source, a connector and source are paired, and each paired connector converts source data between a first format and a second format different from the first format medical protocol; and a core transaction processing system.

### CROSS REFERENCE

The present application is a continuation-in-part of U.S. patent application Ser. No. 13/107,664, filed May 13, 2011, which is incorporated herein in its entirety be reference.

### TECHNICAL FIELD

The present teachings are directed toward the improved collection of clinically relevant data from untraditional sources of profile data for a patient. In particular, the disclosure relates to collection of analysis and utilization of profile data from social networking websites using a secured data source. In some embodiments, secure sources can also obtain generally restricted profile data. Data from untraditional sources can be used to enhance clinical workflows like monitoring post-procedure complications and preventing fraud.

### BACKGROUND

Prior art systems fail to utilize untraditional profile data to perform established clinical processes. One untraditional source of clinical data is social web-sites. Another untraditional source of clinical data is restricted profile data. Prior art systems also do not allow access to untraditional profile data through a secured platform. Moreover, different vendors of the same or similar untraditional profile data use different and varying protocols to collect, store and transmit data. As such, data acquisition, data storage, data retrieval, and data interpretation require custom programming and purchase of vendor specific software. Therefore, there is a need to provide a robust across the board analysis tool that works in a heterogeneous environment to collect and collate the untraditional profile data. The collated data can be used to implement clinical workflow enhancements. There is also a need to standardize the heterogeneous untraditional clinical data and use of varying analysis on the untraditional clinical data.

### SUMMARY

According to various embodiments, a system can comprise: a plurality of data stores comprising untraditional profile data; a gateway communicating with the data stores; a database comprising a patient medical record, a prescribed protocol, and a rule set describing the prescribed protocol; and a medical rule evaluator for accessing the rule set and applying the rule set to the untraditional profile data to determine key indicators. In some embodiments, the alert can comprise warnings and errors. In some embodiments, the system can comprise transmitting the untraditional profile data to a healthcare provider for display.

In some embodiments, the gateway can comprise a connector to standardize the untraditional profile data. 6 In some embodiments, the gateway can be disposed remote from the healthcare provider. In some embodiments, the untraditional profile data is provided by different providers. In some embodiments, the gateway tags the data with a patient ID and a patient location.

In some embodiments, the prescribed protocol comprises one or more of a quality of service protocol, a mental health check protocol, a fraud prevention protocol, a delivery of prescribed services protocol, or a combination thereof.

According to various embodiments, a system can comprise: a data collection system comprising a plurality of data sources and a plurality of connectors, wherein the data sources include data from a untraditional profile data source and a caregiver data store, a connector and source are paired, and each paired connector converts source data between a first format and a second format different from the first format; a rules engine and a medical rule associated with a medical protocol; and a core transaction processing system configured to apply the medical rule to the data in the second format to implement a compliance rules check of the medical protocol.

In some embodiments, the application of the medical rule confirms patient compliance with the medical protocol. In some embodiments, the application of the medical rule confirms caregiver compliance with the medical protocol. In some embodiments, the application of the medical rule generates health status data. In some embodiments, the application of the medical rule generates a mental health profile of the patient.

In some embodiments, the data sources further can comprise one or more of a body area network sensor, an Electronic Health Record (EHR), an Electronic Medical Record (EMR), an Hospital Information Services (HIS) record, a public personal profile, a restricted personal profile, geo-location data, or route data. In some embodiments, the connector converts data from the second format to the first format and the system generates an external actionable event.

The system can comprise a data integrator to collate data from at least two data sources. In some embodiments, the system can comprise a display to view the data from the data sources in the second format.

### BRIEF DESCRIPTION OF THE DRAWINGS

The same reference number represents the same element on all drawings. It should be noted that the drawings are not necessarily to scale. The foregoing and other objects, aspects, and advantages are better understood from the following detailed description of a preferred embodiment of the invention with reference to the drawings, in which:

FIG. 1 is an embodiment of a secure platform capable of integrating untraditional profile data according to one embodiment;

FIG. 2 is an embodiment of how software can be logically connected to provide the systems and methods of the present teachings;

FIG. 3 is a logical diagram of utilizing untraditional profile data according to one embodiment;

FIG. 4 is an embodiment of a data integrator according to one embodiment; and

FIG. 5 is an embodiment of a data flow diagram for a use case or workflow usable for mental health profile creating and scoring.

### DETAILED DESCRIPTION

During a typical healthcare event, a patient is subjected to many processes aimed at providing the patient with health related assistance and functioning of clinic related operations. Such processes can be directly related to a physical clinic, for example, the patient can fill out an admission form upon arrival, the patient can undergo a surgery, or the patient can be subjected to medical treatment. The patient can be also subjected to processes that are indirectly related to a clinic or a group of care providing units based on diagnosis or patient answers to questions. For example, the patient can answer health related questions through the interne or by phone. Activities performed by a patient while interacting with the clinic staff, for example, by calling an operator for scheduling an appointment, can be recorded by the clinic staff.

In some embodiments, a clinic can represent any form of an operational unit of health care. In some embodiments, a clinical process can represent any healthcare related processes involving a clinic in any combination of interactions between patient, doctor, data systems and operational entities.

### Untraditional Profile Data

Examples of untraditional profile data include, but are not limited to: private social data, public social data, other public data and restricted access sites. Public social data for a person can be obtained from many public data sources such as Facebook, MySpace, blogs, review, and comments. Other public data can include, for example, jobs listed by employment related organizations and internet portals, and free online skill/ability tests. Restricted availability untraditional profile data of a person can include, for example, driving records, credit history, and legal records.

### Technology:

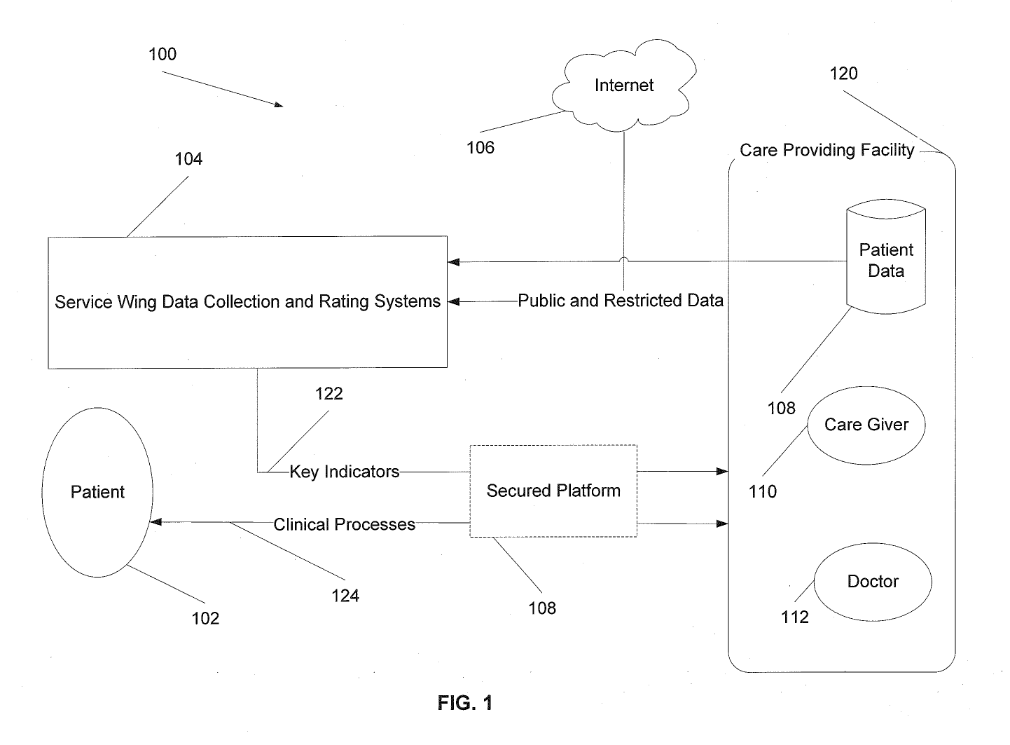

FIG. 1 is an embodiment of a secure system 100 capable of integrating untraditional profile data with an EMR according to one embodiment. A patient 102 can be associated with an EMR. A network 106, such as the internet, can provide access to the various repositories of untraditional profile data. A data collection and rating system 104 can access the untraditional profile data from network 106. Additionally, an integrator or data collection and rating system 104 can access traditional patient data 108 maintained by a care providing facility 120. Key indicators 122 can be determined by the integrator data collection and rating system 104. In some embodiments a secured platform 108 can input or make available the key indicators 122 to care providing facility 120. Patient data 108 can be updated to reflect key indicators 122. Information about clinical processes 124 can flow to and from the secured platform 108 to the care providing facility 120. Authorized personnel, such as a care giver 110 or a doctor 112, can access, manage and manipulate patient data 108. Authorized personnel, such as care giver 110 or doctor 112, can access, manage and manipulate key indicators 122 and manipulate patient data 108. Authorized personnel, such as care giver 110 or doctor 112, can access, manage and manipulate clinical process 124 information and manipulate patient data 108. Integrator 104 can also comprise a rule database. System 100 can be used for specific workflows or use cases of the same to generate actionable events for several applications including medical compliance check, patient monitoring, caregiver/patient alerts and service validation. System 100 can provide alerts.

System 100 can present the collected and analyzed data using a presentation system, for example, a web-server. The system can present the data in a homogenous user interface as needed by a healthcare provider. In some embodiments, the healthcare domain data stores can include such exemplary systems as an EMR system holding patient data, an ERP system or other data store systems located at point of care. The untraditional profile data can be converted and formatted, in order to obtain homogenized data. The homogenized data from the various sources can be collated. In some embodiments, the collated data can be used implement clinical workflow enhancements.

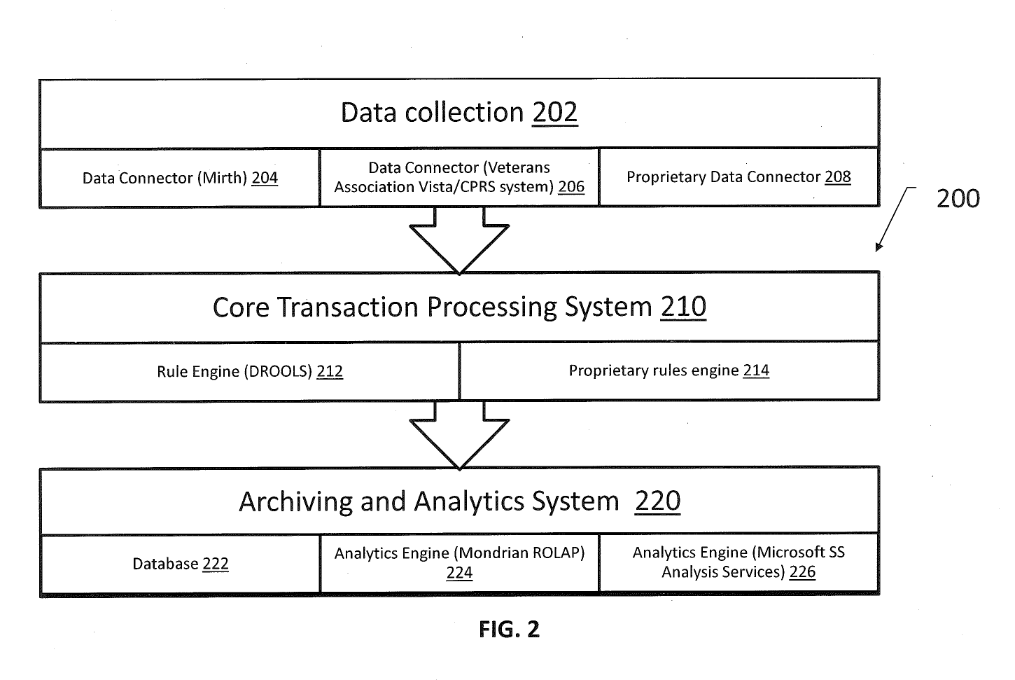

FIG. 2 is an embodiment of how software can be logically connected to provide the systems and methods of the present teachings. A technology stack 200 can be used to implement the software. In a preferred embodiment, data collection 202 can be provided using a combination of various data connectors. In some embodiments data connector 204 can be provided by Mirth connect software described at http://www.mirthcorp.com/products/mirth-connect. In some embodiments, a data connector 206 for connecting a data flow to and from U.S. Veterans Association (VA) EMR system can be provided. Other connectors 208 can be provided as needed. The data collected via data connectors 202 is then homogenized and processed through a core transaction processing engine 210. Transaction processing engine 210 can use active and passive alerts. In some embodiments, the alerts can be via Rule engine 212 implemented using DROOLS (a Java based business logic processor). In some embodiments Rule engine 212 can be used in used in conjunction or replaced with a propriety rules engine 214. Propriety rules engine 214 can be written in Microsoft VC++ and .Net. Data from data connectors 202 can be processed real-time for customer defined business rules resulting into actionable events.

Processed data is then stored using an archival and analytics system 220. In some embodiments, archival system 220 can include a database 222, for example, a MySQL database. Archival and analytics system 220 can be exposed to customers for reporting. Archival and analytics system 220 can comprise an analytics engine 224 that uses, for example, an open source Mondrian ROLAP interface. Archival and analytics system 220 can comprise an analytics engine 226 that uses, for example, Microsoft SSAS (SQL Server Analytical Services) 224.

The present teachings save costs in custom programming because ‘connectors’ for specific data acquisition from various untraditional data sources are provided. The connectors can be built into the system. In some embodiments, the connectors can be provided to a user on Software as a Service (SaaS) basis. So for example, a newly data source can be available for all users without significant re-engineering costs to the connector provider. In some embodiments, the connectors can be borrowed or purchased from industry approved solutions in market. In some embodiments, the connectors can be indigenous.

In a preferred embodiment, a data gateway capable of using configured connectors to accept data from various sources is described. The gateway can be connected to data producers or sources. Connectors can be used to connect to data sources.

The gateway can be connected to data sinks or consumers, which can be humans or physiometric instruments. Data consumers generally interpret the data. Connectors can be used to connect to data consumers.

The correlation of the acquired data is enhanced after it has been homogenized/standardized within a core system. In some embodiments, the interpretation of data, either by humans or processors is targeted to specific use cases. In specific use cases, meaningful correlation of such homogenized data greatly enhances the value of the data. The correlation can be enhanced by the following exemplary means:
Increase the scope of relations from targeted use case or workflow to hospital/enterprise wide scope
Expose homogenized data for writing enterprise level business rules while keeping the source of the information transparent to end user
Make correlated data available for real-time as well as analyzed decisions (this is not the case with currently available data interpreters)
Allow access to singular (i.e., current mental status per a social site) as well as historical (i.e., mental status recorded by patient over the last 3 months) data parameters while creating business rules.
Provide out of the box business rules (i.e., never events) which can be readily adapted by enterprises using our system.

The standardized data can be plugged into a medical protocol. In some embodiments, the standardized data can be integrated and/or associated with a Patient's Medical Record (PMR). In some embodiments, the standardized data can be relayed back to any EMR system connected to the system. The integration can be used to provide significant benefits to a user. For example, the integration can post alarms if recommended protocols are not followed by a patient or a service provider. In some embodiments, payments to a service provider can be authorized post acquisition and integration of data related to the service provided for a selected patient. In some embodiments, the integration can be used for findings of fact or for other data mining activities.

The present teachings use business rules at enterprise level rather the traditional use of triggers at a workflow level.

### Mental Health Evaluations:

A patient may need to undergo mental health evaluations as required by the care giving facility, e.g., periodic, as necessary, or initial screening. One example of such an evaluation is a returning veteran undergoing PTSD evaluation. In such a scenario, the veteran or patient may have to answer questions on his current financial status, marital status and level of frustration. Answers provided by the patient can be enriched with key indicators based on additional information collected from available legal data sources. Pertinent information can include known stressors, for example, whether patient is associated with a bankruptcy, behind in their bills, a divorce filing, DUI tickets, criminal activities, other incidents involving the legal system, etc. The pertinent information can be collected from data sources that are available publicly or in a restricted fashion.

Such indicators enable the caregiver to observe any anomaly and recheck some of the answers provided by the patients. With this additional information, the better informed caregiver can provide the correct therapy to the patient.

### Job Search:

Some treatments include assisting a patient with a job search. For example, when a returning veteran tries to find a job in the civilian world, it is very important that they be provided with relevant job listings. The routine of a job assists in settling the veteran. A clinical process for a subset of veterans evaluates them for mental health conditions periodically. This evaluation includes presenting the veteran with jobs matching his mental health condition. The present teachings can automatically search available applicable jobs on internet portals, and deliver the search results directly to the veteran/patient to encourage him getting back to civilian life. Such searches can be customized based on clinical decisions of the caregiver.

### Application of Technology

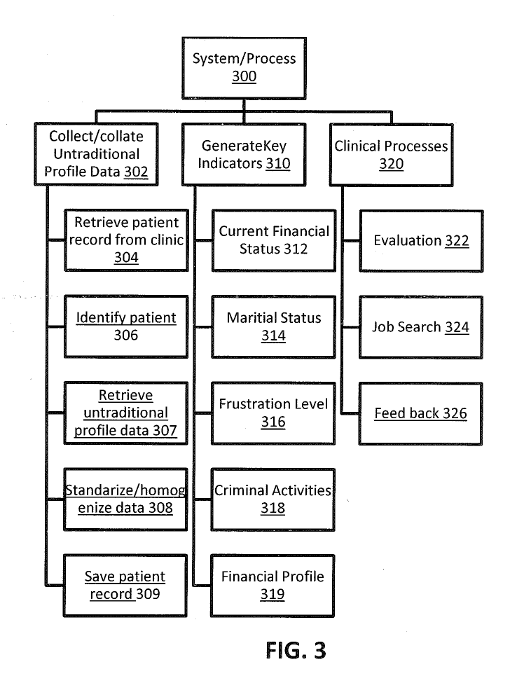

FIG. 3 is a logical diagram of utilizing untraditional profile data according to a system/process 300. The core/gateway technology stack described above is further utilized for various business and domain specific applications. Process/system 300 collects untraditional profile data 302 by retrieving a patient record from 304, identifying the patient 306, retrieving untraditional profile data 307 (using, for example, a customized connector), standardizes/homogenizes the retrieved data 308, and optionally saves relevant untraditional profile data to the patient record. The collected/collated data can be used to generate key indicators 310. Exemplary generated key indicators 310 can comprise one or more of current financial status 312, marital status 314, frustration level 316, criminal activities 318 and a financial profile 319. The generated key indicators 310 can be used to inform clinical/medical processes 320. Exemplary clinical processes 320 for treating a mental health diagnosis can include frequency of evaluation 322, job search 324 and patient feedback 326.

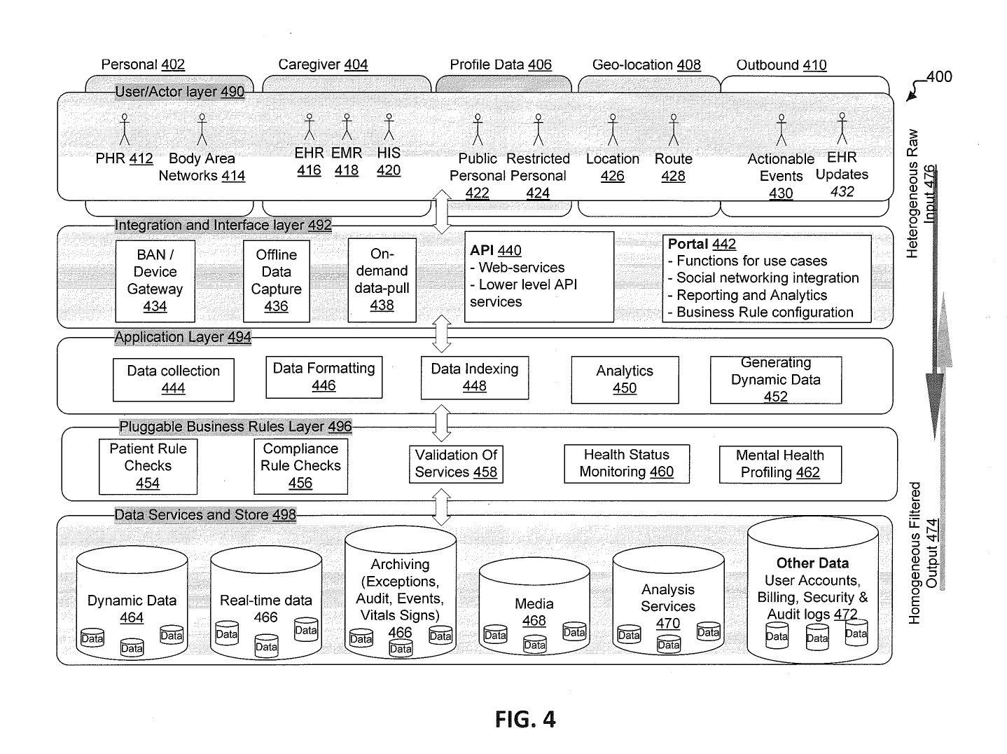

FIG. 4 is an embodiment of a data integrator 400 that accepts data from various heterogeneous health, medical and bio data sources, stores the data in a homogenous format, collates the data and makes the data available for other applications for applying business rules. A user/actor layer 490 of data integrator 400 can obtain personal data 402, caregiver data 404, profile data 406, and/or geo-location data 408. The data can be divided into one or more of these categories. Data integrator 400 can retrieve a Personal Health Record (PHR) 412, physiological data collected from a body area network (BAN) 414, an EHR 416, an EMR 418, data from a HIS 420, or a combination thereof. In some embodiments, profile data 406 like a public personal profile 422 or a restricted personal profile 424. In some embodiments, geo-location data 408 can comprise a location 426 or a route 428. In some embodiments, data integrator 400 can include outbound connectors 410 for actionable events 430 or for EHR updates 432. User/actor layer 490 can interface with an integration and interface layer 492 which can include connectors to the various categories of data available to user/actor layer 490. In some embodiments, one or more of a BAN/device connector, an offline data capture 436, or an on-demand data-pull 438 can be provided. Integration and interface layer 492 can also provide an application protocol interface (API) 440. API 440 can provide web-services. In some embodiments, API 440 can provide lower level API services. In other embodiments, integration and interface layer can include a portal 442. Portal 442 can provide functions to access, manage and define use cases. In some embodiments, portal 442 can provide an interface for social networking integration. In other embodiments, portal 442 can provide an interface for reporting and analytics. In a preferred embodiment, portal 442 can include a business tool configuration and definition interface.

Integration and interface layer 492 can interface with an application layer 494. Application layer 494 can include one or more of a data collection 444, data formatting 446, data indexing 448, analytics 450, and generating dynamic data 452 module. Application layer 494 can interface with a pluggable business rules layer 496. Pluggable business rules layer 496 can include one or more of a patient rules check 454, a compliance rules check 456, a validation of services 458, a health status monitoring 460, a mental health profiling 462 module. Pluggable business rules layer 496 can interface with a data services and store layer 498. Data services and store layer 498 can be capable of storing dynamic data 464, real-time data 466, archiving 468, media 468, analysis services 470, or any other data 472 needed by the data integrator 400. Archiving 468 can store exceptions, audit events, events, vital signs etc. Other data 472 can include, for example, user accounts, billing, security logs, or audit logs. In some embodiments, application layer 494 can collate the data received at user/actor layer 490. According to various embodiments, pluggable business rules layer 496 can collate the data received at user/actor layer 490.

The following examples illustrate how the present teachings can be used.

### Mental Health

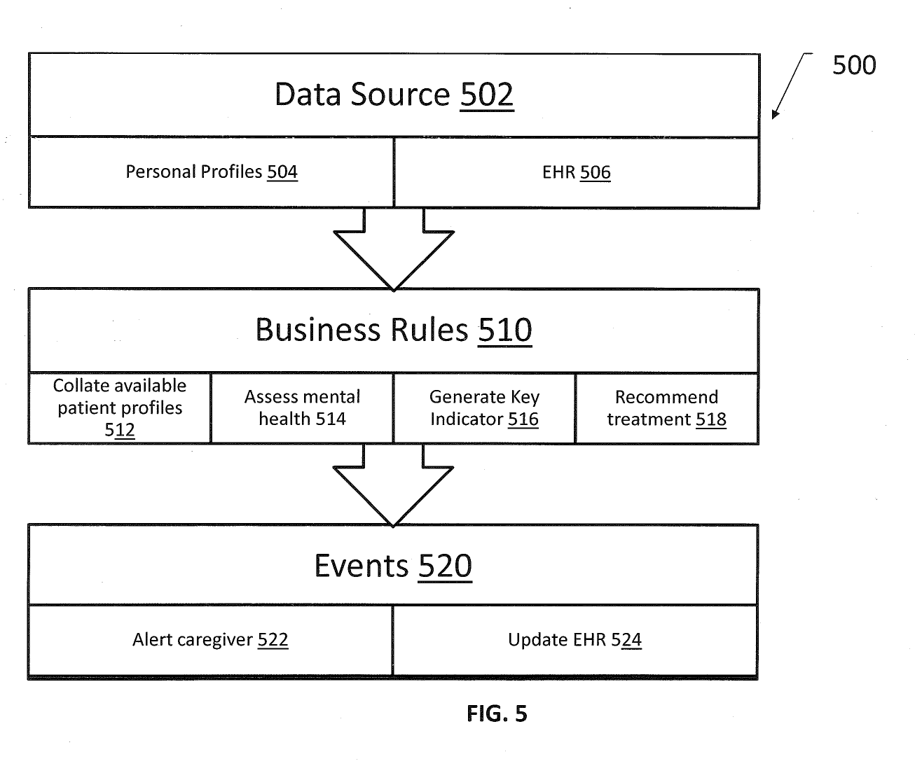

FIG. 5 shows an embodiment, where a system 500 can be used to create and score individuals profile using data obtained from an individual EHR. The information can include public and restricted personal profiles 502. When a new EHR 506, for example, a veteran's record, is received into the EHR system, the system can invoke business rule 510. Business rule 510 can retrieve a profile 504 and EHR 806. In some embodiments, profile data 504 may not exist in the healthcare data domain. In such events, profile data 504 can be collected by business rule 510 from government sources (e.g., military records, NCIC database), or from private sources (e.g., credit reports, employment records), or from other sources. Social networking sites such as, facebook, linkedin can be used to generate one or more profiles. Per the rule engine 510, the available patient profiles can be collated 512. Further to rule engine 510, the patient's mental health is then assessed by the system. The assessment can generate a key indicator 516. In some embodiments, rule engine 510 can recommend treatment 518 of a patient. If deemed medically necessary by the system and/or health care provider, events 520 can be generated. Events 520 can alert caregiver 822 to contact the patient. In some embodiments, alert caregiver 522 can contact the patient through the web for a mental health assessment built for suicide prevention. The resulting scores of the assessment packet from business rule 510 can then be entered into the EHR system for clinicians review. For example, the rule structure can comprise:

When
Patient.PerformMentalHealthCheck==true AND
Patient.MentalHealthAssesmentDetails <are> available

Then—
KeyIndicators=Patient.MentalHealthAssesmentScore+
Patient.MentalHealthAssesmentDetails+
Patient.PublicFeeds.FinancialScore+
Patient.PublicFeeds.LegalScore
Patient.EMR.SubmitClinicalNote(KeyIndicators).

In some embodiments, personal profiles are publicly available and legally obtainable. In some embodiments, private profile data comprises profiles including but not limited to social network profiles, financial data, driving records, legal records.

In some embodiments, dynamic dimensional data is not restricted to a business of medical function or use case. This is a homogeneous form of data obtained from heterogeneous data sources.

Actionable Events comprise events, alerts and notifications generated by the system when the data qualifies configurable business rules.

Business Rules comprise Business function/domain/use case specific rules which are user configured, and the system needs to apply on available data.

The EHR server software used and maintained by certain U.S. government agencies including Veteran's Administration (VA) and Department of Defense (DoD) is named Vista. CPRS is the EHR client software used and maintained by certain U.S. government agencies including VA and DoD. RPC is the TCP/IP based non-public interface CPRS uses to talk with Vista.

In some embodiments, the system and method can be implemented by a third party service provider for a health service provider. The third party service provider can be accessed over the web or over a private network. In some embodiments, the system and method can be implemented in the internet cloud.

The various embodiments described above are provided by way of illustration only and should not be constructed to limit the invention. Those skilled in the art will readily recognize the various modifications and changes which may be made to the present invention without strictly following the exemplary embodiments illustrated and described herein, and without departing from the true spirit and scope of the present invention, which is set forth in the following claims.

1. A system for impacting clinical processes comprising:
a plurality of data stores comprising untraditional profile data;
a gateway communicating with the data stores;
a data integrator to collate the untraditional profile data;
a database comprising a patient medical record, a prescribed protocol, and a rule set describing the prescribed protocol; and
a medical rule evaluator that is configured to access the rule set and apply the rule set to the collated untraditional profile data to generate key indicators.

2. The system of claim 1, wherein the alert comprises warnings and errors.

3. The system of claim 1, further comprising transmitting the collated untraditional profile data to a healthcare provider for display.

4. The system of claim 1, wherein the gateway comprises a connector to standardize the collated untraditional profile data.

5. The system of claim 1, wherein the untraditional profile data is provided by different providers.

6. The system of claim 1, wherein the gateway is disposed remote from the healthcare provider.

7. The system of claim 1, wherein the collated untraditional profile data includes a patient ID and a patient location.

8. The system of claim 1, wherein the prescribed protocol comprises one or more of a quality of service protocol, a mental health check protocol, a fraud prevention protocol, a delivery of prescribed services protocol, or a combination thereof.

9. The system of claim 1, wherein the data integrator integrates the collated untraditional profile data with one or more of a Patient Medical Record (PMR), an Electronic Health Record (EHR), an Electronic Medical Record (EMR), or an Hospital Information Services (HIS) record.

10. A system comprising:
a data collection system comprising a plurality of data sources and a plurality of connectors, wherein the data sources include data from a untraditional profile data source and a clinical data source, a connector and source are paired, and each paired connector converts source data between a first format and a second format different from the first format;
a rules engine and a medical rule associated with a medical protocol; and
a core transaction processing system configured to apply the medical rule to the data in the second format to implement a compliance rules check of the medical protocol.

11. The system of claim 10, wherein the application of the medical rule confirms patient compliance with the medical protocol.

12. The system of claim 11, wherein the application of the medical rule confirms a clinician's compliance with the medical protocol.

13. The system of claim 10, wherein the application of the medical rule generates health status data.

14. The system of claim 10, wherein the application of the medical rule generates a mental health profile of the patient.

15. The system of claim 10, wherein the data sources further comprise one or more of a body area network sensor, an EHR, an EMR, an HIS record, a public personal profile, a restricted personal profile, geo-location data, or route data.

16. The system of claim 10, wherein the connector converts data from the second format to the first format and the system generates an external actionable event.

17. The system of claim 10, further comprising a data integrator to collate data from at least two data sources.

18. The system of claim 10, further comprising a display to view the data from the data sources in the second format.

19. A method comprising:
collecting data from a plurality of data sources including a untraditional profile data source and a clinical data source;
pairing a connector and source, and each paired connector converts source data between a first format and a second format different from the first format;
providing a rules engine and a medical rule associated with a medical protocol; and
applying the medical rule to the data in the second format to implement a compliance rules check of the medical protocol.
